(19) United States
(12) Patent Application Publication
(10) Pub. No.: US 2018/0004380 A1
(43) Pub. Date: Jan. 4, 2018

(54) SCREEN DISPLAY METHOD AND ELECTRONIC DEVICE SUPPORTING THE SAME

(71) Applicant: Samsung Electronics Co., Ltd., Gyeonggi-do (KR)

(72) Inventor: Gonghwan JUNG, Gyeonggi-do (KR)

(21) Appl. No.: 15/637,697

(22) Filed: Jun. 29, 2017

(30) Foreign Application Priority Data
Jul. 4, 2016 (KR) 10-2016-0084136

(51) Int. Cl. G06F 3/0485; G06F 3/0488; H04M 1/725

(52) U.S. Cl. CPC G06F 3/0485; G06F 3/0488; H04M 1/725

(57) ABSTRACT

An electronic device is provided which includes a display, a touchscreen panel, a processor, and a memory which stores commands for executing a surface flinger, wherein the memory stores commands which when executed, cause the processor to generate the plurality of surface images associated with the application, store the surface images in the memory, check the at least one surface image for a first part corresponding to the screen display window, generate a first screen page based on the first part, display the first screen page on the display, check, when movement of the screen display window is detected, the at least one surface image for a second part corresponding to the moved screen display window, generate a second screen page based on the second part, and display the second screen page in place of the first screen page on the display.

### PRIORITY

This application claims priority under 35 U.S.C. §119(a) to Korean Patent Application Serial No. 10-2016-0084136,which was filed on Jul. 4, 2016 in the Korean Intellectual Property Office, the entire content of which is incorporated herein by reference.

### BACKGROUND

### 1. Field of the Disclosure

The present disclosure generally relates to a screen display method and electronic device supporting the same, and more particularly, to a method and electronic device for displaying a screen image navigated in response to a screen transition scroll.

### 2. Description of the Related Art

In line with the advancement of digital technology, diverse types of electronic devices (such as a mobile communication terminal, a personal digital assistant (PDA), an electronic dictionary, a smartphone, and a tablet personal computer (PC)) that are capable of mobile communication and computing are being commercialized.

Typically, such electronic devices are manufactured in a compact and slim design for portability and equipped with a touchscreen for providing a convenient user interface. A touchscreen-equipped electronic device may display a certain image on the touchscreen, the image being produced through a rendering process.

The electronic device has to perform the rendering process repeatedly to generate images changed as the user navigates the image viewed on a display screen. However, if the rendering process is performed as the image viewed on the display screen is moved in a direction, this may increase electric current consumption and degrade operation performance.

### SUMMARY

The present disclosure has been made to address at least the above disadvantages and other disadvantages not described above, and to provide at least the advantages described below.

According to an aspect of the present disclosure, a screen display method and electronic device are provided which are capable of reducing power consumption and performance degradation by minimizing rendering times.

In accordance with an aspect of the present disclosure, an electronic device is provided which includes a display including a touchscreen panel, a processor, a memory which is electrically connected to the processor and stores a command for executing a surface flinger which generates a screen page based on part of at least one surface image corresponding to a screen display window among a plurality of surface images associated with an application, wherein the memory stores commands, which when executed, cause the processor to generate the surface images associated with the application, store the surface images in the memory, check the at least one surface image for a first part corresponding to the screen display window, generate a first screen page based on the first part, display the first screen page on the display, check, when movement of the screen display window is detected, the at least one surface image for a second part corresponding to the moved screen display window, generate a second screen page based on the second part, and display the second screen page in place of the first screen page on the display.

In accordance with another aspect of the present disclosure, a screen display method of an electronic device is provided which includes generating a plurality of surface images associated with an application, storing the surface images in a memory, checking at least one surface image for a first part corresponding to a screen display window, generating a first screen page based on the first part, displaying the first screen page on a display, rechecking, when movement of the screen display window is detected, the at least one surface image for a second part corresponding to the moved screen display window, generating a second screen page based on the second part, and displaying the second screen page in place of the first screen page on the display.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating a configuration of an electronic device in a network environment, according to an embodiment of the present disclosure;

FIG. 2 is a block diagram illustrating a configuration of an electronic device, according to an embodiment of the present disclosure;

FIG. 3 is a block diagram illustrating a configuration of a program module, according to an embodiment of the present disclosure;

FIG. 4 is a flowchart illustrating an operation of an electronic device, according to an embodiment of the present disclosure;

FIG. 5 is a block diagram illustrating a configuration of a program module for processing the operation of FIG. 4, according to an embodiment of the present disclosure;

FIG. 6 is a diagram illustrating surface images of an electronic device, according to an embodiment of the present disclosure;

FIG. 7 is a diagram illustrating a surface image storage structure, according to an embodiment of the present disclosure;

FIG. 8 is a diagram illustrating a surface image storage structure, according to an embodiment of the preset disclosure;

FIG. 9 is a diagram illustrating a surface image storage structure, according to an embodiment of the present disclosure;

FIGS. 10A and 10B are diagrams illustrating a screen display method of an electronic device, according to an embodiment of the present disclosure; and

FIGS. 11A and 11B are diagrams illustrating a screen display method of an electronic device, according to an embodiment of the present disclosure.

### DETAILED DESCRIPTION

The following description with reference to the accompanying drawings is provided to assist in a comprehensive understanding of certain embodiments of the present disclosure as defined by the claims and their equivalents. It includes various specific details to assist in the understanding but these are to be regarded as merely exemplary. Accordingly, those of ordinary skill in the art will recognize that various changes and modifications of the embodiments described herein may be made without departing from the scope and spirit of the present disclosure. In addition, descriptions of well-known functions and constructions may be omitted for clarity and conciseness.

The terms and words used in the following description and claims are not limited to their dictionary meanings, but are used to enable a clear and consistent understanding of the present disclosure. Accordingly, it should be apparent to those skilled in the art that the following description of embodiments of the present disclosure is provided for illustration purposes only and not for the purpose of limiting the present disclosure, as defined by the appended claims and their equivalents.

It is to be understood that the singular forms “a”, “an”, and “the”, include plural forms as well unless the context clearly dictates otherwise. Thus, for example, a reference to “a component surface” includes a reference to one or more of such surfaces.

The expressions “include” and “may include” which may be used in the present disclosure denote the presence of the disclosed functions, operations, and elements, and do not limit one or more additional functions, operations, and elements. In the present disclosure, the terms “include” and/or “have”, may be construed to denote a certain characteristic, number, operation, constituent element, component or a combination thereof, but should not be construed to exclude the existence of, or a possibility of, the addition of one or more other characteristics, numbers, operations, constituent elements, components or combinations thereof.

In the present disclosure, the expression “and/or” includes any and all combinations of the associated listed words. The expression “A and/or B” may include A, may include B, or may include both A and B.

In the present disclosure, expressions including ordinal numbers, such as “first”, “second”, and/or the like, may modify various elements. However, such elements are not limited by the above expressions. The above expressions do not limit the sequence and/or importance of the elements. The above expressions are used merely for the purpose of distinguishing an element from the other elements. For example, a first user device and a second user device indicate different user devices, although both are user devices. For further example, a first element may be referred to as a second element, and similarly, a second element may also be referred to as a first element without departing from the scope of the present disclosure.

In the case where a component is referred to as being “connected to” or “accessed by” another component, it should be understood that not only is the component connected to or accessed by the other component, but also another component may exist between the component and the other component. In the case where a component is referred to as being “directly connected” or “directly accessed” to another component, it should be understood that there is no component therebetween.

Unless otherwise defined, all terms including technical and/or scientific terms used herein have the same meaning as commonly understood by one of ordinary skill in the art to which the present disclosure pertains. In addition, unless otherwise defined, all terms defined in generally used dictionaries may not be interpreted to have ideal or excessively formal meanings.

According to an embodiment of the present disclosure, the electronic device may include at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player (e.g., moving picture experts group phase 1 or phase 2 (MPEG-1 or MPEG-2) audio layer 3 (MP3) player), a mobile medical device, a camera, or a wearable device. Examples of the wearable device include a head-mounted-device (HIVID) (e.g., electronic eyeglasses), electronic clothing, an electronic bracelet, an electronic necklace, an appcessory, an electronic tattoo, a smart watch, and the like.

The electronic device, according to an embodiment of the present disclosure, may also include various smart home appliances. Examples of such smart home appliances may include a television (TV), a digital versatile disc (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, and the like.

The electronic device, according to an embodiment of the present disclosure, may also include medical devices (e.g., magnetic resonance angiography (MRA), magnetic resonance imaging (MM), computed tomography (CT), a scanning machine, an ultrasonic scanning device, and the like), a navigation device, a global positioning system (GPS) receiver, an event data recorder (EDR), a flight data recorder (FDR), a vehicle infotainment device, an electronic equipment for ships (e.g., navigation equipment, gyrocompass, and the like), avionics, a security device, a head unit for vehicles, an industrial or home robot, an automatic teller machine (ATM), a point of sales (POS) system, and the like.

The electronic device according to an embodiment of the present disclosure may also include furniture or a portion of a building/structure, an electronic board, an electronic signature receiving device, a projector, various measuring instruments (e.g., a water meter, an electric meter, a gas meter and a wave meter) and the like. The electronic device may also include a combination of the devices listed above. In addition, the electronic device may be a flexible and/or contoured device. It should be obvious to those skilled in the art that the electronic device is not limited to the aforementioned devices.

Hereinafter, electronic devices according to an embodiment of the present disclosure will be described in detail with reference to the accompanying drawings. In the description, the term ‘user’ may refer to a person or a device (e.g., an artificial intelligence electronic device) that uses or otherwise controls the electronic device.

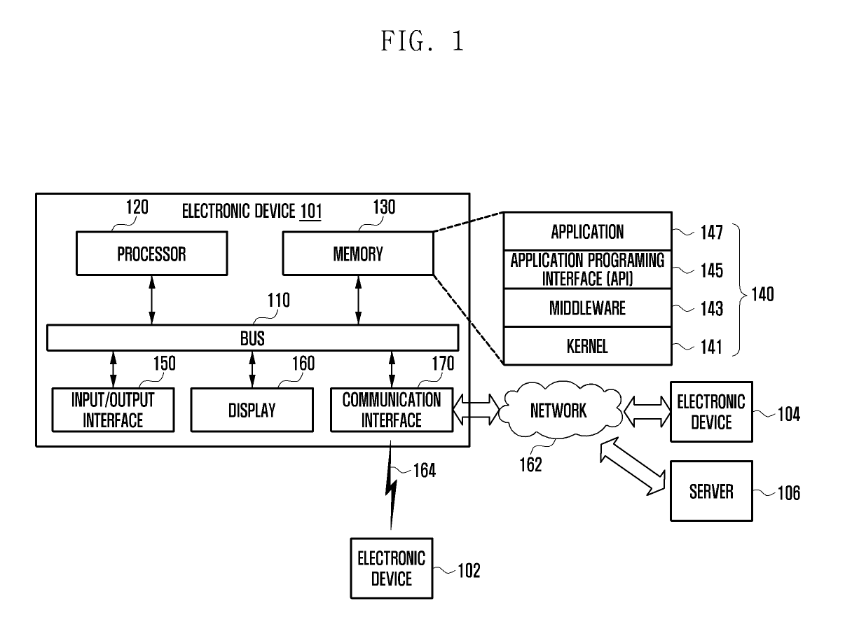

FIG. 1 is a block diagram illustrating a configuration of an electronic device in a network environment, according to an embodiment of the present disclosure.

Referring to FIG. 1, an electronic device 101 includes a bus 110, a processor 120 (i.e., at least one processor), a memory 130, an input/output (I/O) interface 150, a display 160 and a communication interface 170.

The bus 110 may be a communication circuit that connects the components to each other and transfers data (e.g., control messages) between the components.

The processor 120 may receive instructions from the components (e.g., the memory 130, I/O interface 150, display 160 and communication interface 170) via the bus 110, decode the instructions and perform corresponding operations or data processing according to the decoded instructions.

The memory 130 may store instructions or data transferred from/created in the processor 120 or the other components (e.g., I/O interface 150, display 160 and communication interface 170). The memory 130 includes programming modules, e.g., a kernel 131, a middleware 132, an application programming interface (API) 133, and an application module 134. Each of the programming modules may be software, firmware, hardware or a combination thereof.

The kernel 131 may control or manage system resources (e.g., the bus 110, processor 120, and memory 130) used to execute operations or functions of the programming modules, e.g., the middleware 132, API 133, and application module 134. The kernel 131 may also provide an interface that may access and control/manage the components of the electronic device 101 via the middleware 132, API 133, and application module 134.

The middleware 132 may make it possible for the API 133 or application module 134 to perform data communication with the kernel 131. The middleware 132 may also perform control operations (e.g., scheduling and load balancing) for task requests transmitted from the application module 134 using, for example, a method for assigning the order of priority to use the system resources (e.g., the bus 110, processor 120, and memory 130) of the electronic device 101 to at least one of the applications of the application module 134.

The API 133 is an interface that allows the application module 134 to control functions of the kernel 131 or middleware 132. The API 133 may include at least one interface or function (e.g., instruction) for file control, window control, character control, video process, and the like.

In an embodiment of the present disclosure, with reference to FIG. 1, the application module 134 may include applications that are related to short message service (SMS)/multimedia messaging service (MMS), email, calendar, alarm, health care (e.g., an application for measuring blood sugar level, a workout application, and the like), and environment information (e.g., atmospheric pressure, humidity, temperature, and the like). The application module 134 may be an application related to exchanging information between the electronic device 101 and an external electronic device 104. The information exchange-related application may include a notification relay application for transmitting specific information to an external electronic device or a device management application for managing external electronic devices.

The notification relay application may include a function for transmitting notification information, created by the other applications of the electronic device 101 (e.g., SMS/MMS application, email application, health care application, environment information application, and the like), to the electronic device 104. In addition, the notification relay application may receive notification information from the external electronic device 104 and provide it to the user. The device management application may manage (e.g., install, delete, or update) part of the functions of the external electronic device 104 communicating with the electronic device 101, e.g., turning on/off the external electronic device, turning on/off part of the components of the external electronic device, adjusting the brightness or the display resolution of the display of the external electronic device, and the like, applications operated in the external electronic device, or services from the external electronic device, e.g., call service or messaging service, and the like.

In an embodiment of the present disclosure, the application module 134 may also include applications designated according to attributes (e.g., type of electronic device) of the external electronic device 104. For example, if the external electronic device 104 is an MP3 player, the application module 134 may include an application related to music playback. If the external electronic device 104 is a mobile medical device, the application module 134 may include an application related to health care. The application module 134 may include an application designated in the electronic device 101 and applications transmitted from the server 106, electronic device 104, and the like.

The I/O interface 150 may receive instructions or data from the user via an I/O system (e.g., a sensor, keyboard or touch screen) and transfers them to the processor 120, memory 130 or communication interface 170 through the bus 110. The I/O interface 150 may provide data corresponding to a user's touch input to a touch screen to the processor 120. The I/O interface 150 may receive instructions or data from the processor 120, memory 130 or communication interface 170 through the bus 110, and output them to an I/O system (e.g., a speaker or a display). The I/O interface 150 may output voice data processed by the processor 120 to a speaker.

The display 160 may display information (e.g., multimedia data, text data, and the like) on a screen so that the user may view it.

The communication interface 170 may communicate between the electronic device 101 and an external electronic device 104 or server 106. The communication interface 170 may connect to a network 162 in a wireless or wired mode, and communicate with the external system. Wireless communication may include wireless fidelity (Wi-Fi), Bluetooth™ (BT), near field communication (NFC), GPS or cellular communication (e.g., long term evolution (LTE), LTE-advanced (LTE-A), code division multiple access (CDMA), wideband CDMA (WCDMA), universal mobile telecommunications system (UMTS), wireless broadband (Wi-Bro), global system for mobile communications (GSM), and the like). In addition, the wireless communication may include, for example, short-range communication 164. Wired communication may include universal serial bus (USB), high definition multimedia interface (HDMI), recommended standard 232 (RS-232), plain old telephone service (POTS), and the like.

In an embodiment of the present disclosure, the network 162 may be a telecommunication network. The telecommunication network may include a computer network, the Internet, the Internet of things (IoT), a telephone network, and the like. The protocol for communication between the electronic device 101 and the external system, e.g., transport layer protocol, data link layer protocol, or physical layer protocol, may be supported by at least one of the application module 134, API 133, middleware 132, kernel 131 and communication interface 170.

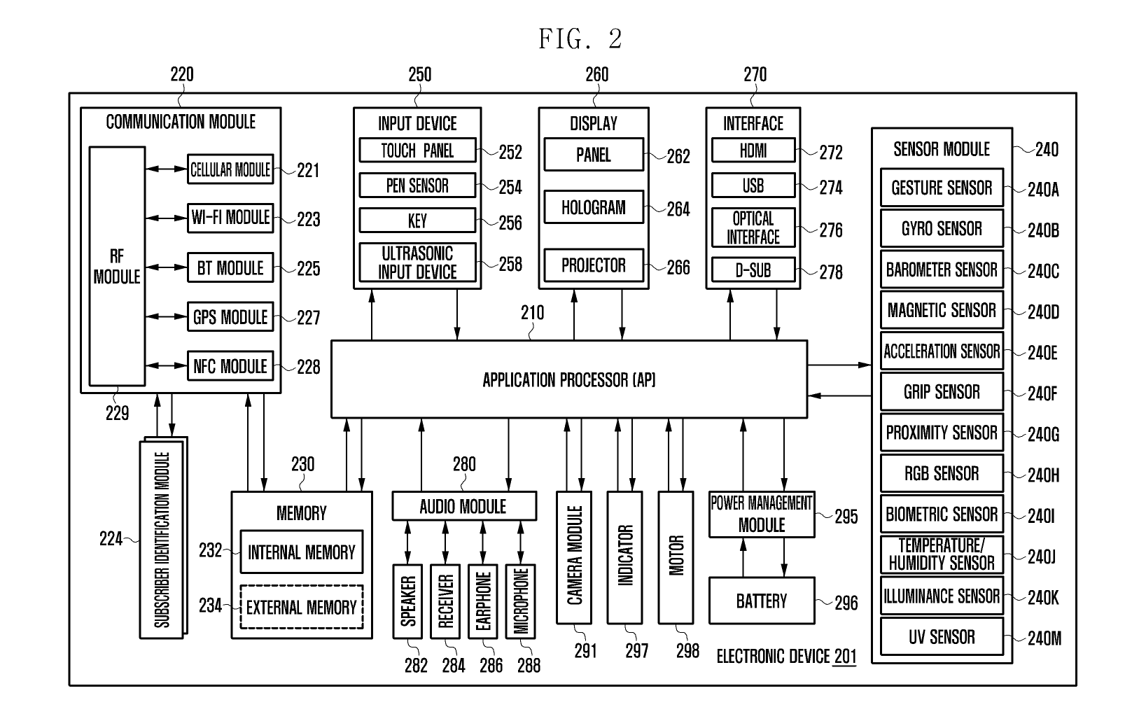

FIG. 2 illustrates a block diagram of an electronic device according to an embodiment of the present disclosure.

Referring to FIG. 2, an electronic device 201 may be all or part of the electronic device 101 as shown in FIG. 1, and includes one or more processors of an application processor (AP) 210, a communication module 220, a subscriber identification module (SIM) card 224, a memory 230, a sensor module 240, an input device 250, a display module 260, an interface 270, an audio module 280, a camera module 291, a power management module 295, a battery 296, an indicator 297, and a motor 298.

The AP 210 may control a number of hardware or software components connected thereto by executing the operating system or applications, process data including multimedia data, and perform corresponding operations. The AP 210 may be implemented with a system on chip (SoC). In an embodiment of the present disclosure, the AP 210 may further include a graphics processing unit (GPU).

The communication module 220 performs communication for data transmission/reception between an electronic device 102 or 104, and server 106 that are connected to the electronic device 101 via the network. In an embodiment of the present disclosure, the communication module 220 includes a cellular module 221, a Wi-Fi module 223, a BT module 225, a GPS module 227, an NFC module 228 and a radio frequency (RF) module 229.

The cellular module 221 may provide voice call, video call, SMS or Internet service, and the like, via a communication network (e.g., LTE, LTE-A, CDMA, WCDMA, UMTS, Wi-Bro, GSM, and the like). The cellular module 221 may also perform identification or authentication for electronic devices in a communication network by using the SIM card 224. In an embodiment of the present disclosure, the cellular module 221 may perform part of the functions of the AP 210. The cellular module 221 may perform part of the functions for controlling multimedia.

In an embodiment of the present disclosure, the cellular module 221 may include a communication processor (CP). The cellular module 221 may be implemented with, for example, an SoC. Although the embodiment of the present disclosure shown in FIG. 2 is implemented in such a way that the cellular module 221, the power management module 295, the memory 230, and the like, are separate from the AP 210, an embodiment of the present disclosure may be modified such that the AP 210 includes at least part of the listed elements or other elements of the device 201 (e.g., cellular module 221).

In an embodiment of the present disclosure, the AP 210 or the cellular module 221 may load instructions or data transmitted to and from at least one of a non-volatile memory or other components, to a volatile memory and then process them. The AP 210 or the cellular module 221 may also store data which is transmitted from/created in at least one of the components, in a non-volatile memory.

The Wi-Fi module 223, the BT module 225, the GPS module 227 and the NFC module 228 may include processors for processing transmission/reception of data, respectively. Although the embodiment of the present disclosure shown in FIG. 2 is implemented such that the cellular module 221, Wi-Fi module 223, BT module 225, GPS module 227, and NFC module 228 are separate from each other, an embodiment of the present disclosure may be modified such that parts of the elements (e.g., two or more) are included in an integrated chip (IC) or an IC package. For example, part of the processors corresponding to the cellular module 221, Wi-Fi module 223, BT module 225, GPS module 227, and NFC module 228, e.g., a CP corresponding to the cellular module 221 and a Wi-Fi processor corresponding to the Wi-Fi module 223, may be implemented with an SoC.

The RF module 229 may transmit or receive data, e.g., RF signals. The RF module 229 may include a transceiver, a power amplifier module (PAM), a frequency filter, a low noise amplifier (LNA), and the like. The RF module 229 may also include parts for transmitting/receiving electromagnetic waves, e.g., conductors, wires, and the like, via free space during wireless communication. Although the embodiment of the present disclosure shown in FIG. 2 is implemented in such a way that the cellular module 221, Wi-Fi module 223, BT module 225, GPS module 227, and NFC module 228 share the RF module 229, an embodiment of the present disclosure may be modified such that at least one of the elements transmit or receives RF signals via a separate RF module.

The SIM card 224 may be inserted into a slot of the electronic device. The SIM card 224 may include unique identification information, e.g., integrated circuit card identifier (ICCID), or subscriber information, e.g., international mobile subscriber identity (IMSI).

The memory 230 includes built-in or internal memory 232 and/or external memory 234. The internal memory 232 may include at least one of a volatile memory, e.g., dynamic random access memory (DRAM), static RAM (SRAM), synchronous dynamic RAM (SDRAM), and the like, non-volatile memory, e.g., one time programmable read only memory (OTPROM), programmable ROM (PROM), erasable and programmable ROM (EPROM), electrically erasable and programmable ROM (EEPROM), mask ROM, flash ROM, NAND flash memory, NOR flash memory, and the like.

In an embodiment of the present disclosure, the internal memory 232 may be a solid state drive (SSD). The external memory 234 may include a flash drive, e.g., compact flash (CF), secure digital (SD), micro-SD, mini-SD, extreme digital (XD), a memory stick, and the like. The external memory 234 may be functionally connected to the electronic device via various types of interfaces. The electronic device 101 may further include storage devices or storage media such as hard drives.

The sensor module 240 may measure a physical quantity or sense operation states of the electronic device 201 and convert the measured or sensed data into electrical signals. The sensor module 240 includes at least one of a gesture sensor 240A, a gyro sensor 240B, an atmospheric pressure (barometer) sensor 240C, a magnetic sensor 240D, an acceleration sensor 240E, a grip sensor 240F, a proximity sensor 240G a color sensor 240H (e.g., a red-green-blue (RGB) sensor), a biosensor (biometric sensor) 2401, a temperature/humidity sensor 240J, an illuminance sensor 240K, and an ultra-violet (UV) sensor 240M.

The sensor module 240 may also include an electronic nose (e-nose) sensor, electromyography (EMG) sensor, an electroencephalogram (EEG) sensor, an electrocardiogram (ECG) sensor, an infrared (IR) sensor, a fingerprint sensor, an iris sensor, and the like. The sensor module 240 may further include a control circuit for controlling the one or more sensors.

The input device 250 includes a touch panel 252, a pen sensor 254 (i.e., a digital pen sensor or digital stylus), a key 256 and an ultrasonic input device 258. The touch panel 252 may sense a touch using a capacitive sensing mode, a pressure sensing mode, an infrared sensing mode, and an ultrasonic sensing mode. The touch panel 252 may further include a control circuit. When the touch panel 252 is designed to operate in a capacitive sensing mode, the panel may also sense mechanical/physical touches or proximity of an object. The touch panel 252 may further include a tactile layer. In that case, the touch panel 252 may also provide tactile feedback to the user.

The pen sensor 254 (i.e., digital pen sensor) may be detected in a same or similar way as receiving a user's touch input or by using a separate recognition sheet. The key 256 may include mechanical buttons, optical keys or a key pad. The ultrasonic input device 258 is a device that may sense sounds via a microphone 288 of the electronic device 201 by using an input tool for generating ultrasonic signals, and then receiving and checking data associated with the signals. The ultrasonic input device 258 may sense signals in a wireless mode. In an embodiment of the present disclosure, the electronic device 201 may also receive a user's inputs from an external system (e.g., a computer or server) via the communication module 220.

The display module 260 includes a panel 262, a hologram unit 264, or a projector 266. The panel 262 may be implemented with a liquid crystal display (LCD), active matrix organic light emitting diodes (AMOLEDs), and the like. The panel 262 may be implemented in a flexible, transparent, impact-resistant, and/or wearable form. The panel 262 may form a single module with the touch panel 252. The hologram unit 264 shows a three-dimensional image in the air using interference of light. The projector 266 may display images by projecting light on a screen. The screen may be placed, for example, inside or outside of the electronic device 201. In an embodiment of the present disclosure, the display module 260 may further include a control circuit for controlling the panel 262, the hologram unit 264, or the projector 266.

The interface 270 includes an HDMI 272, a USB 274, an optical interface 276, a D-subminiature (D-sub) 278, and the like. The interface 270 may also be included in the communication interface 170 shown in FIG. 1. The interface 270 may also include a mobile high-definition link (MHL) interface, an SD card, a multi-media card (MMC) interface, an infrared data association (IrDA) standard interface, and the like.

The audio module 280 may provide conversions between audio and electrical signals. At least part of the components in the audio module 280 may be included in the I/O interface 150 shown in FIG. 1. The audio module 280 may process audio output from/input to, for example, a speaker 282, a receiver 284, earphones 286, the microphone 288, and the like.

The camera module 291 may take still images or moving images. In an embodiment of the present disclosure, the camera module 291 may include one or more image sensors (e.g., on the front side and/or the back side), a lens, an image signal processor (ISP), a flash (e.g., an LED or a xenon lamp), and the like.

The power management module 295 may manage electric power supplied to the electronic device 201. The power management module 295 may include a power management integrated circuit (PMIC), a charger IC, a battery gauge, and the like.

The PMIC may be implemented in the form of an IC chip or SoC. Charging electric power may be performed in wired and/or wireless modes. The charger IC may charge a battery, and prevent input over-voltage or input over-current to the battery from a charger. In an embodiment of the present disclosure, the charger IC may be implemented with a wired charging type and/or a wireless charging type. Examples of the wireless charging type of the charger IC are a magnetic resonance type, a magnetic induction type, an electromagnetic type, an acoustic type, and the like. If the charger IC is implemented with a wireless charging type, it may also include an additional circuit for wireless charging, e.g., a coil loop, a resonance circuit, a rectifier, and the like.

The battery gauge may measure a residual charge amount of the battery 296, a level of voltage, a level of current, a temperature during the charge, and the like. The battery 296 stores electric power and supplies it to the electronic device 201. The battery 296 may include a rechargeable battery or a solar battery.

The indicator 297 shows states of the electronic device 201 or of the parts thereof (e.g., the AP 210), e.g., a booting state, a message state, a recharging state, and the like. The motor 298 converts an electrical signal into a mechanical vibration. The electronic device 201 may include a processor for supporting a mobile TV, e.g., a GPU. The mobile TV supporting processor may process media data that complies with standards of digital multimedia broadcasting (DMB), digital video broadcasting (DVB), Mediaflo™, and the like.

Each of the elements/units of the electronic device according to an embodiment of the present disclosure may be implemented with one or more components, and may be called different names according to types of electronic devices. The electronic device may include at least one element described above. The electronic device may also be modified in such a way as to remove part of the elements or include new elements. In addition, the electronic device may also be modified such that parts of the elements are integrated into one entity that performs their original functions.

In the present disclosure, the term ‘module’ refers to a ‘unit’ including hardware, software, firmware or a combination thereof. The term ‘module’ may be interchangeably used with the terms ‘unit,’ logic,“logical block,' component,”circuit,' and the like. A ‘module’ may be the least identifiable unit or part of an integrated component. A ‘module’ may also be the least unit or part thereof that may perform one or more functions of the module. A ‘module’ may be implemented through mechanical or electronic modes. For example, ‘modules’ according to an embodiment of the present disclosure may be implemented with at least one of an application specific integrated circuit (ASIC) chip, a field-programmable gate array (FPGAs) and a programmable-logic device that may perform functions that are known or will be developed.

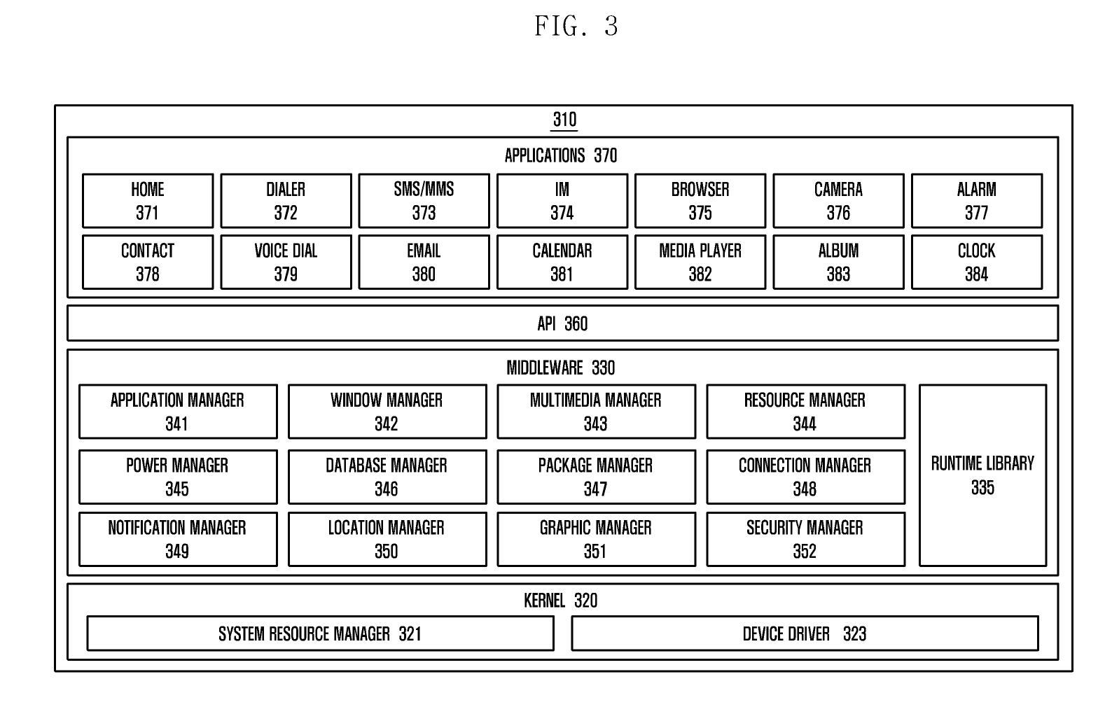

FIG. 3 is a block diagram of a program module according to an embodiment of the present disclosure.

Referring to FIG. 3, a program module 300 may include an operating system (OS) for controlling resources related to the electronic device and/or various applications executed in the operating system. The OS may be, for example, Android™, iOS™, Window™, Symbian®, Tizen®, Bada®, and the like.

The program module 300 includes a kernel 320, middleware 330, an API 360, and/or applications 370. At least some of the program module 300 may be preloaded on an electronic device, or may be downloaded from the electronic device 102 or 104, or the server 106.

The kernel 320 includes, for example, a system resource manager 321 and/or a device driver 323. The system resource manager 321 may perform control, allocation, retrieval, and the like, of system resources. The system resource manager 321 may include a process manager, memory manager, file system manager, and the like. The device driver 323 may include, for example, a display driver, camera driver, BT driver, shared memory driver, USB driver, keypad driver, Wi-Fi driver, audio driver, or inter-process communication (IPC) driver.

The middleware 330 may provide a function required by the applications 370 in common, or provide various functions to the applications 370 through the API 360 so that the applications 370 may efficiently use limited system resources within the electronic device. According to an embodiment of the present disclosure, the middleware 330 includes, for example, at least one of a runtime library 335, an application manager 341, a window manager 342, a multimedia manager 343, a resource manager 344, a power manager 345, a database manager 346, a package manager 347, a connectivity (connection) manager 348, a notification manager 349, a location manager 350, a graphic manager 351, and a security manager 352.

The runtime library 335 may include a library module which a compiler uses in order to add a new function through a programming language while the applications 370 are being executed. The runtime library 335 may perform I/O management, memory management, functionality for an arithmetic function, and the like.

The application manager 341 may manage, for example, a life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the corresponding format. The resource manager 344 may manage resources such as a source code, memory, and storage space of at least one of the applications 370.

The power manager 345 may operate together with a basic input/output system (BIOS) to manage a battery or other power, and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or BT. The notification manager 349 may display or notify of an event, such as an arrival message, appointment, proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic device has a telephone call function, the middleware 330 may further include a telephony manager for managing a voice call function or a video call function of the electronic device.

The middleware 330 may include a middleware module that forms a combination of various functions of the above-described elements. The middleware 330 may provide a module specialized for each type of OS in order to provide a differentiated function. In addition, the middleware 330 may dynamically delete some of the existing elements, or may add new elements as required.

The API 360 is, for example, a set of API programming functions, and may be provided with a different configuration according to an OS. For example, in the case of Android™ or iOS™, one API set may be provided for each platform. In the case of Tizen™, two or more API sets may be provided for each platform.

The applications 370 includes, for example, one or more applications which may provide functions such as home 371, dialer 372, SMS/MMS 373, instant message (IM) 374, browser 375, camera 376, alarm 377, contacts 378, voice dialer 379, email 380, calendar 381, media player 382, album 383, clock 384, health care (e.g., measure exercise quantity or blood sugar level), or environment information (e.g., atmospheric pressure, humidity, or temperature information).

According to an embodiment of the present disclosure, the applications 370 may include an information exchange application supporting information exchange between the electronic device and an external electronic device 102 or 104. The information exchange application may include, for example, a notification relay application for transferring specific information to an external electronic device or a device management application for managing an external electronic device.

The notification relay application may include a function of transferring, to the external electronic device 102 or 104, notification information generated from other applications of the electronic device 101 (e.g., an SMS/MMS application, e-mail application, health management application, or environmental information application). Further, the notification relay application may receive notification information from, for example, an external electronic device and provide the received notification information to a user.

The device management application may manage (e.g., install, delete, or update), for example, at least one function of an external electronic device 102 or 104 communicating with the electronic device (e.g., a function of turning on/off the external electronic device or some components thereof, or a function of adjusting luminance or a resolution of the display), applications operating in the external electronic device, or services provided by the external electronic device (e.g., a call service and a message service).

According to an embodiment of the present disclosure, the applications 370 may include an application (e.g., a health care application of a mobile medical device and the like) designated according to an attribute of the external electronic device 102 or 104. The applications 370 may include an application received from the server 106, or the external electronic device 102 or 104. The applications 370 may include a preloaded application or a third party application which may be downloaded from the server. Names of the elements of the program module 300, according to the above-described embodiments of the present disclosure, may change depending on the type of OS.

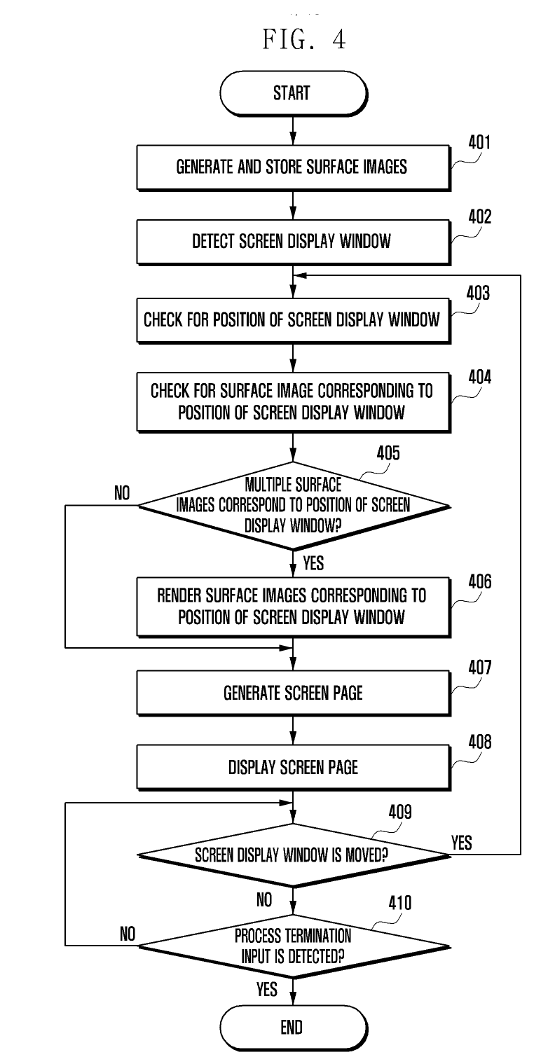

The screen display methods and electronic devices supporting the screen display methods according to an embodiment of the present disclosure are described in detail with reference to FIGS. 4 to 9, 10A, 10B, 11A, and 11B.

In an embodiment of the present disclosure, the term “surface image” may be an image associated with an application. An electronic device may control an application to render primitive data into a surface image. It may be possible that a plurality of surface images are generated in association with the application currently running on the electronic device.

In the present disclosure, a description is made in association with the surface images transitioning from one to another in response to a user's screen transition input among plural surface images.

According to an embodiment of the present disclosure, the application may be an application for generating a home screen. An application-related surface image may include an indicator bar having a time indication icon, a battery charging state indication icon, a communication progress indication icon, a background image, and a menu image having menu icons.

In an embodiment of the present disclosure, the term “screen display window” may denote a window corresponding to part of a surface image, the part being displayed on the screen of an electronic device in the size of the screen display window. The screen display window may be an indicator indicating a part of the surface image to be displayed on the screen.

In an embodiment of the present disclosure, the menu image as one of the surface images may be cropped into multiple images in the size of a screen display window, the cropped images being stored as surface images.

In an embodiment of the present disclosure, if a user input for navigating the image viewed on the screen is detected on the screen, the image to be viewed in response to the user input may be a surface image changed in response to the user input and corresponding to the screen display window.

In an embodiment of the present disclosure, the position of the screen display window changed in response to the user input may correspond to a position of part of each surface image obtained by cropping in the size of the screen display window.

In an embodiment of the present disclosure, the term “screen page” may denote an image generated by composing part of the surface images corresponding to the detected screen display window to fit the frame designated for display on the screen of the electronic device.

The screen image may also denote an image generated by composing part of the surface images corresponding to the detected screen display window and other surface images to fit a frame designated for displaying image on the screen of the electronic device. The image, i.e., the screen page, is output to the screen of the electronic device.

FIG. 4 is a flowchart illustrating an operation of an electronic device, according to an embodiment of the present disclosure.

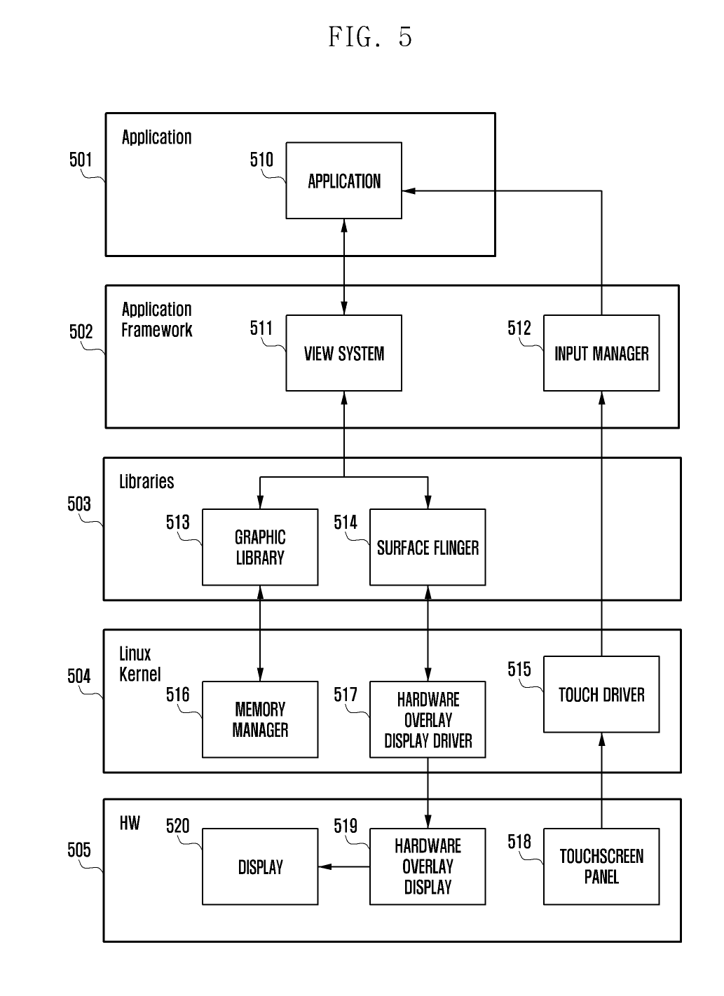

FIG. 5 is a block diagram illustrating a configuration of a program module for processing the operation of FIG. 4, according to an embodiment of the present disclosure.

First described is the configuration of the program module with reference to FIG. 5 and then the operation of the electronic device is described with reference to FIG. 4. In reference to FIG. 5, the program module includes at least one of an application layer 501, an application framework layer 502, a libraries layer 503, a Linux kernel layer 504, and a hardware layer 505. The configuration of the program module is well known in the art; thus, a detailed description thereof is omitted.

The application layer 501 includes at least one application 510, and examples of the application 510 include applications for performing the functions of the home 371, the dialer 372, the SMS/MMS 373, the IM 374, the browser 375, the camera 376, the alarm 377, the contact 378, the voice dial 379, the email 380, the calendar 381, the media player 382, the album 383, the clock 384, the payment 385, and as shown in FIG. 3, the health care (e.g., workout amount or blood sugar level measurement), and the environment information (e.g., atmospheric pressure, humidity, and temperature information) provision function.

The application framework layer 502 includes a view system 511 and an input manager 512. The view system 511 of the application framework 502 may generate surface images and compose the surface images into a screen page to be displayed on the screen. The input manager 512 of the application framework 502 may detect a touch input on a touch panel 518 by means of a touch driver 515 and determine whether the touch input is a user's screen transition input.

The libraries layer 503 includes at least one of a graphic library 513 and a surface flinger 514. A graphic processing device or a processor may generate a surface image using the graphic library 513 upon receipt of a command from the application 510.

The surface flinger 514 of the libraries layer 503 may compose the surface images generated by the view system 511 into a screen page. The surface flinger 514 may control the view system 511 of the application framework layer 502 to compose multiple surface images into a screen page.

The Linux kernel 504 includes at least one of a touch driver 515, a memory manager 516, and a hardware (HW) overlay display driver 517.

The touch driver 515 of the Linux kernel 504 may detect a user input made on the touchscreen and acquire information on the detected user input from the touchscreen panel 518 of the hardware layer 505 and send the information to the input manager 512 of the application framework layer 502.

The memory manager 516 of the Linux kernel 504 may store at least one surface image generated as above.

The HW overlay display driver 517 of the Linux kernel 504 may control storing in its memory buffer at least one screen page generated under the control of the surface flinger 514 of the libraries layer 503.

The hardware layer 505 includes at least one of the touchscreen panel 518, a display 520 and a hardware overlay display 519.

The touchscreen panel 518 of the hardware layer 505 may transfer the information on the touch input to the touch driver 515 of the Linux kernel 504.

The hardware overlay display 519 of the hardware layer 505 includes a memory buffer, which stores the screen image generated by composing the surface images. The display 520 of the hardware layer 505 may include at least part of the display 150 of FIG. 1. The display 520 may display the screen page stored in the memory buffer of the hardware overlay display 519.

The operations of the electronic device is described hereinafter with reference to FIG. 4.

The flowchart of FIG. 4 may depict an operation performed after an application is executed on the electronic device.

The electronic device executes the application 510 and control the view system 511 to generate a surface image upon detection of a command of the application 510 at step 401. The generated surface image may be stored in a by means of the memory manager 516. In an embodiment of the present disclosure, the application 510 may be a home application. The home application may control configuring a home screen.

There may be multiple surface images associated with the home application, and the surface images may include a menu image with multiple icons, a status bar image, a position indication bar image, and a background image. Among them, the surface images transitioning from one to another in response to the user's screen transition input may be menu images with a plurality of icons. The menu images may be the surface images obtained by cropping an image in the size of a screen display window.

The electronic device detects the screen display window at step 402. The screen display window may be an indicator indicating an area of the surface images to be displayed on the screen of the electronic device. The electronic device checks for the position of the screen display window at step 403. The screen display window may correspond to the surface image related to the menu images among the surface images associated with the application 510. In the case where the surface images are generated by cropping a menu image in the size of the screen display window, the screen display window may correspond to parts of multiple surface images.

The electronic device checks for at least part of the surface image corresponding to the position of the moved screen display window at step 404.

The electronic device determines at step 405 whether there are multiple surface images corresponding to the position of the screen display window. The screen display window may be positioned across multiple surface images.

If it is determined at step 405 that there are multiple surface images corresponding to the position of the screen display window, the electronic device renders parts of the multiple surface images corresponding to the position of the screen display window at step 406. The surface flinger 514 of the electronic device composes the rendered surface images and other surface images to generate a screen page at step 407. If the menu images as surface images associated with the home application are obtained by cropping an image in the size of the screen display window, the surface flinger 514 may render parts of the multiple surface images corresponding to the screen display window and compose the rendered surface images and other images such as the status bar image to generate the screen page.

If it is determined at step 405 that there are no multiple surface images corresponding to the position of the screen display window, the operation proceeds to step 407. In an embodiment of the present disclosure, although the surface image related to the menu image is cropped into multiple surface images in the size of the screen display window, it may be possible for one surface image to correspond to the position of the screen display window. The electronic device composes the surface image corresponding to the position of the screen display window and other surface images to generate the screen page at step 407. It may be possible to compose the menu image as a surface image associated with the home application and other surface images such as a status bar image to generate the screen page.

The electronic device displays the generated screen page at step 408. The electronic device may display the screen page generated by means of the hardware overlay display 519 on the display 520 of the hardware layer 505.

The electronic device determines whether the screen display window is moved at step 409. The input manager 512 of FIG. 5 may detect the movement of the screen display window upon receipt of the information on the touch input made on the touchscreen panel 518 via the touch driver 515.

If it is determined at step 409 that the screen display window is moved, the electronic device returns the operation to step 403 to repeat subsequent steps.

If it is determined at step 409 that the screen display window is not moved, the operation proceeds to step 410.

At step 410, the electronic device determines whether a user input for terminating the screen page display process is detected. If it is determined at step 410 that the user input for terminating the screen display process is detected, the electronic device may end the process. Otherwise, if it is determined at step 410 that no user input for terminating the screen display process is detected, the electronic device returns the process to step 409 to wait for the user input for the screen display transition

According to an embodiment of the present disclosure, the initial screen display window may be configured to display part of the surface image implementing the screen page initially displayed on the screen of the electronic device.

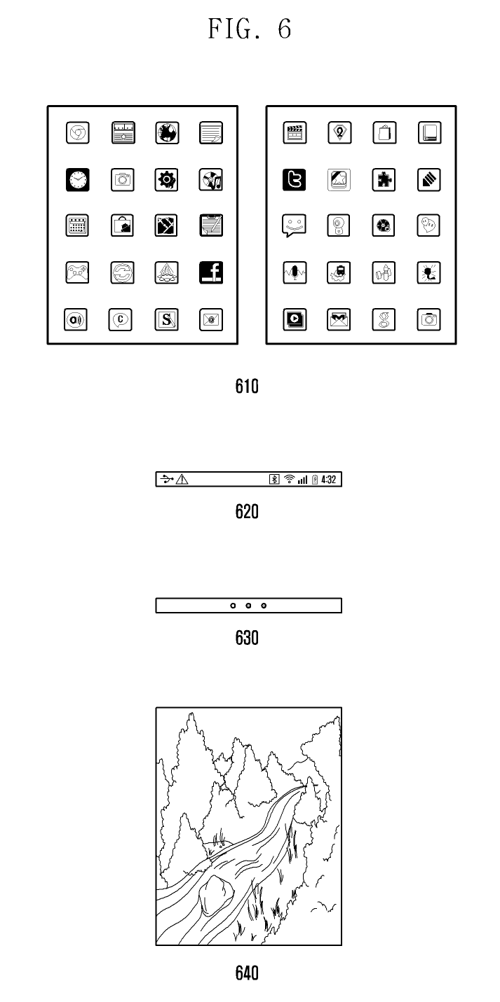

FIG. 6 is a diagram illustrating surface images of the electronic device, according to an embodiment of the present disclosure.

In reference to FIG. 6, reference numerals 610 to 640 denote surface images associated with an application.

The surface images 610 may be menu images that each include a plurality of icons. The menu images may be obtained by cropping one menu image in the size of the screen display window. Each icon included in the menu image may represent an application. According to a user's screen transition input, the menu image is changed to a new one having the icons representing other applications.

The surface image 620 may be a status bar image including icons indicating time, battery charging status, and communication progress.

The surface image 630 may be a location status bar image. The location status bar may roughly indicate the position of the currently viewed part of the whole menu image.

The surface image 640 may be a background image displayed on the screen of the electronic device.

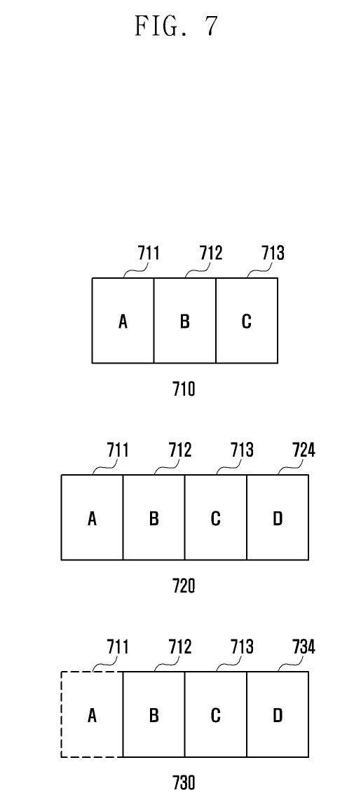

FIG. 7 is a diagram illustrating a surface image storage structure, according to an embodiment of the present disclosure.

The electronic device may store the surface images such that the surface images are each mapped to respective frames of a storage structure. The storage structure may have a size set by the user and may be increased or decreased according to the size of the surface images to be stored.

As denoted by reference numeral 710, the electronic device may store part of the surface images in the storage structure having a size of 1×3. The frame size of 1×1 may be equal to the size of the screen display window. In an embodiment of the present disclosure, the information A, among the surface image information, may be stored in the frame 711. The information B, among the surface image information, may be stored in the frame 712. The information C, among the surface image information, may be stored in the frame 713.

In the state where the surface images obtained by cropping in the size of the screen display window are stored as denoted by reference numeral 710, the electronic device may detect the movement of the screen display window in response to the user's screen transition input. If it is determined that an additional image should be displayed in addition to the surface images, the electronic device may extend the storage structure to have the size of 1×4 for storing the additional surface image as denoted by reference numeral 720. The electronic device may map the additional surface image information D to the frame 724.

In an embodiment of the present disclosure, the electronic device may detect movement of the screen display window in response to the user's screen transition input in the state that part of the surface images are stored as denoted by reference numeral 710. The electronic device may determine that an additional surface image should be displayed in addition to the previously stored surface images.

If the electronic device has a storage unit limited in capacity, it may be impossible to extend the storage structure. In this case, the electronic device may delete at least part of the information stored in the storage structure to add the information D of the added surface image as denoted by reference numeral 730. The electronic device may delete the information A stored in the frame 711. The electronic device may store the information D of the additional surface image in the frame 734 by deleting the information A.

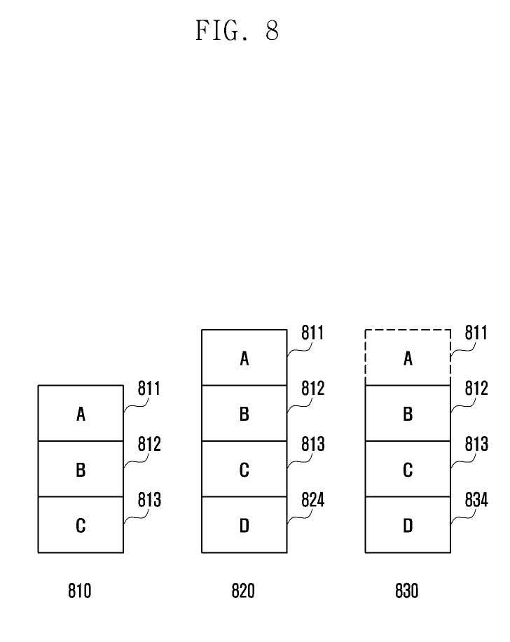

FIG. 8 is a diagram illustrating a surface image storage structure, according to another embodiment of the present disclosure.

The electronic device may store the surface images such a way that the surface images are mapped to the frames of a storage structure having a predetermined size. The storage structure may have a size set by the user and be increased or decreased according to the size of the surface images to be stored.

As denoted by reference numeral 810, the electronic device may store part of the surface images in the storage structure having a size of 3×1. In an embodiment of the present disclosure, the information A, among the surface image information, may be stored in the frame 811. The information B, among the surface image information, may be stored in the frame 812. The information C, among the surface image information, may be stored in the frame 813.

In the state where the surface images obtained by cropping in the size of the screen display window are stored as denoted by reference numeral 810, the electronic device may detect movement of the screen display window in response to the user's screen transition input.

The electronic device may determine that an additional surface image should be displayed in addition to the previously stored surface images. The electronic device may extend the storage structure to have the size of 4×1 for storing the additional surface image as denoted by reference numeral 820. The electronic device may map the additional surface image information D to the frame 824.

In an embodiment of the present disclosure, the electronic device may detect movement of the screen display window in response to the user's screen transition input in the state that part of the surface images are stored as denoted by reference numeral 810. The electronic device may determine that an additional surface image should be displayed in addition to the previously stored surface images.

If the electronic device has a storage unit limited in capacity, it may be impossible to extend the storage structure. In this case, the electronic device may delete at least part of the information stored in the storage structure to add the information D of the added surface image as denoted by reference numeral 830. The electronic device may delete the information A stored in the frame 811. The electronic device may store the information D of the additional surface image in the frame 834 secured by deleting the information A.

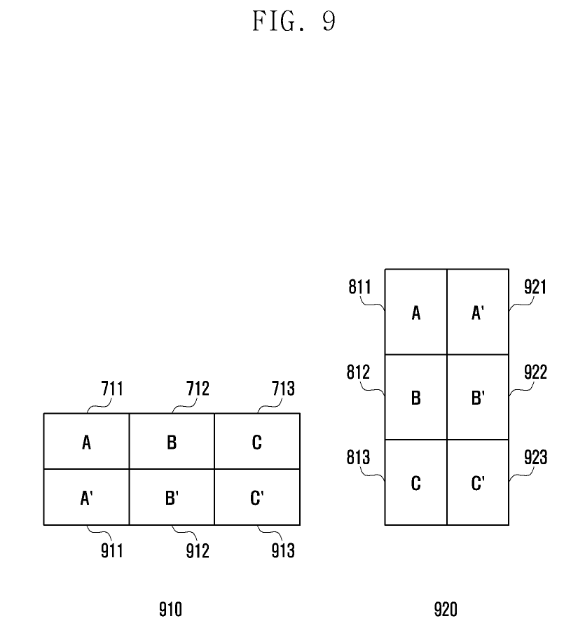

FIG. 9 is a diagram illustrating a surface image storage structure according to another embodiment of the present disclosure.

As denoted by reference numeral 710 of FIG. 7, the electronic device may store part of the surface images in the storage structure having a size of 1×3. In an embodiment of the present disclosure, the parts of the surface images may include information A, B, and C. The information A may be stored in the frame 711. The information B, among the surface image information, may be stored in the frame 712. The information C, among the surface image information, may be stored in the frame 713.

The electronic device may store part of the surface images in the storage structure as denoted by reference numeral 710 of FIG. 7. The stored information may be changed in part according to a user input or as time progresses. If the electronic device detects a change in the information, it may extend the size of the storage structure from 1×3 to 2×3 as denoted by reference numeral 910. The changed versions of the previously stored information A′, B′, and C′ may be stored in the frames 911, 912, and 913, respectively, of the extended storage structure. In an embodiment of the present disclosure, information A′ as the changed version of information A, is stored in the frame 911. Information B′ as the changed version of information B, is stored in the frame 912. Information C′ as the changed version of information C, is stored in the frame 913.

The electronic device may detect that part of information A is changed to information A′ in the course of displaying information A. In this case, the electronic device may compose a pre-stored information A′ such that the change is reflected on the screen of the electronic device without any extra rendering operation.

As denoted by reference numeral 810 of FIG. 8, the electronic device may store part of the surface images in the storage structure having a size of 3×1. In an embodiment of the present disclosure, the information A may be stored in the frame 811. The information B, among the surface image information, may be stored in the frame 812. The information C, among the surface image information, may be stored in the frame 813.

The electronic device may store part of the surface images in the storage structure as denoted by reference numeral 810 of FIG. 8. The stored information may be changed in part according to a user input or as time progresses. If the electronic device detects a change in the information, it may extend the size of the storage structure from 3×1 to 3×2 as denoted by reference numeral 920. The changed versions of the previously stored information A, B, and C may be stored in the frames 921, 922, and 923, respectively, of the extended storage structure. In an embodiment of the present disclosure, information A′ as the changed version of information A, is stored in the frame 921. Information B′ as the changed version of information B, is stored in the frame 922. Information C′ as the changed version of information C, is stored in the frame 923.

The electronic device may detect that part of information A is changed to information A′ in the course of displaying information A. In this case, the electronic device may compose a pre-stored information A′ such that the change is reflected on the screen of the electronic device without any extra rendering operation.

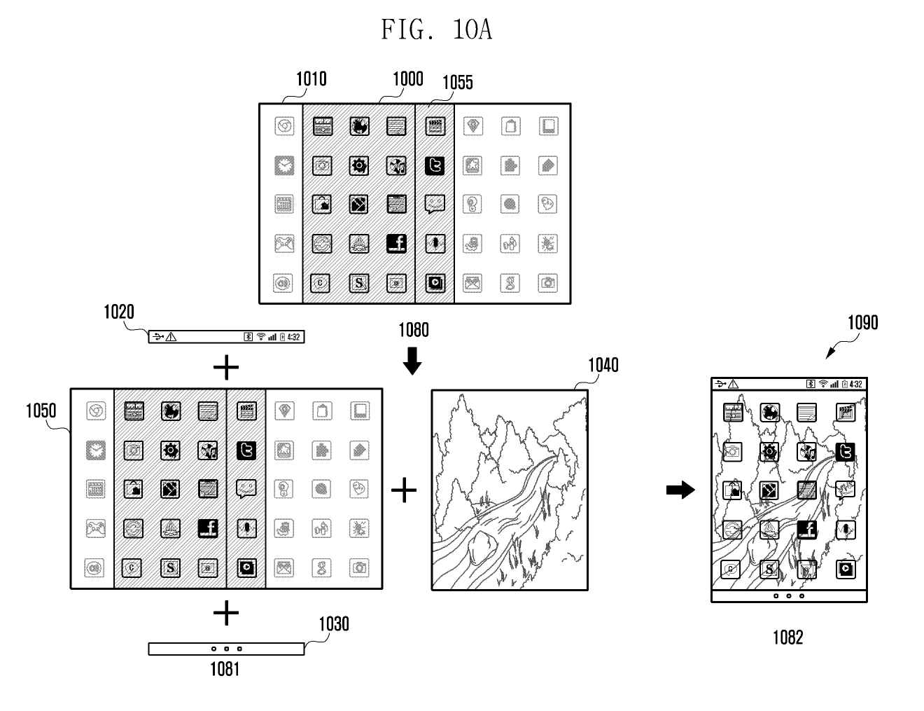

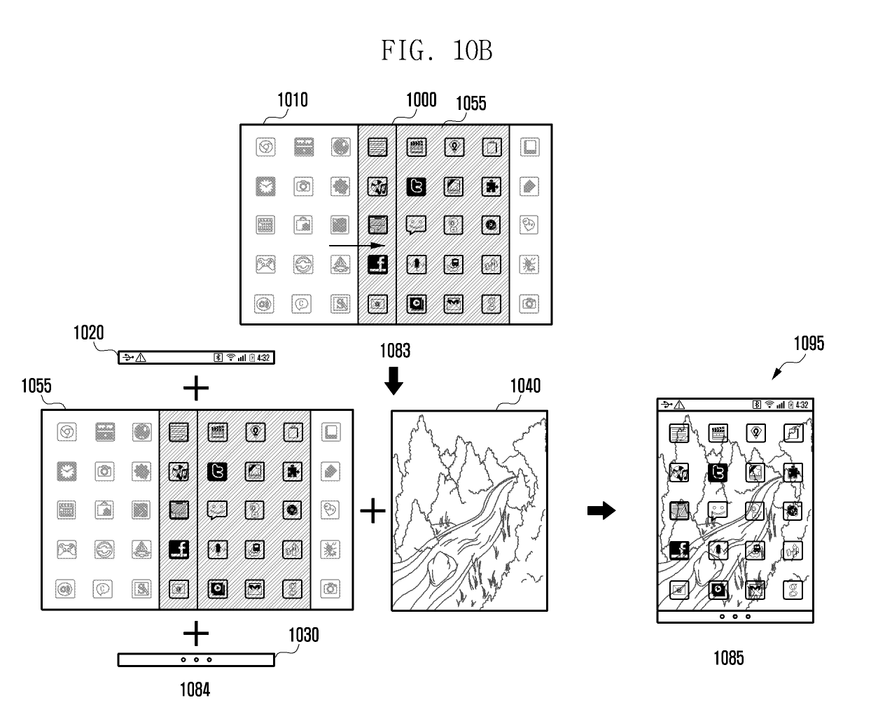

FIGS. 10A and 10B are diagrams illustrating a screen display method of an electronic device, according to an embodiment of the present disclosure.

In FIG. 10A, the electronic device may execute an application, generate a plurality of surface images associated with the executed application, and store the surface images in a storage structure. The electronic device may check for the transitioning surface images among all of the surface images in response to a screen transition input made by the user. According to an embodiment of the present disclosure, the application may be an application for generating a home screen.

As denoted by reference numeral 1080, the electronic device may check the surface image for its part corresponding to the screen display window.

As denoted by reference numeral 1081, the electronic device may compose a screen page based on the checked part of the surface image. If it is determined that parts of multiple surface images correspond to the screen display window as the screen display window moves, the electronic device may render multiple surface images. The electronic device may compose the newly rendered surface images and the surface images generated in association with the execution of the application into a screen page to be displayed on the screen. The surface images may include a status bar, a background image, and a position indication bar.

As denoted by reference numeral 1082, the electronic device may generate a screen page corresponding to the position of the screen display window by composing the surface images associated with the executed application. The electronic device may display the generated screen page.

As denoted by reference numeral 1083 of FIG. 10B, the electronic device may detect movement of the screen display window. The electronic device may check the surface image for its part corresponding to the moved screen display window.

As denoted by reference numeral 1084, the electronic device may generate a screen page based on at least the checked part of the surface image. If it is determined that parts of multiple surface images correspond to the screen display window as the screen display window moves, the electronic device may render multiple surface images. The electronic device may compose the newly rendered surface images and the surface images generated in association with the execution of the application into a screen page to be displayed on the screen. The surface images may include a status bar, a background image, and a position indication bar.

As denoted by reference numeral 1085, the electronic device may generate a screen page corresponding to the position of the screen display window by composing the surface images associated with the executed application. The electronic device may display the generated screen page.

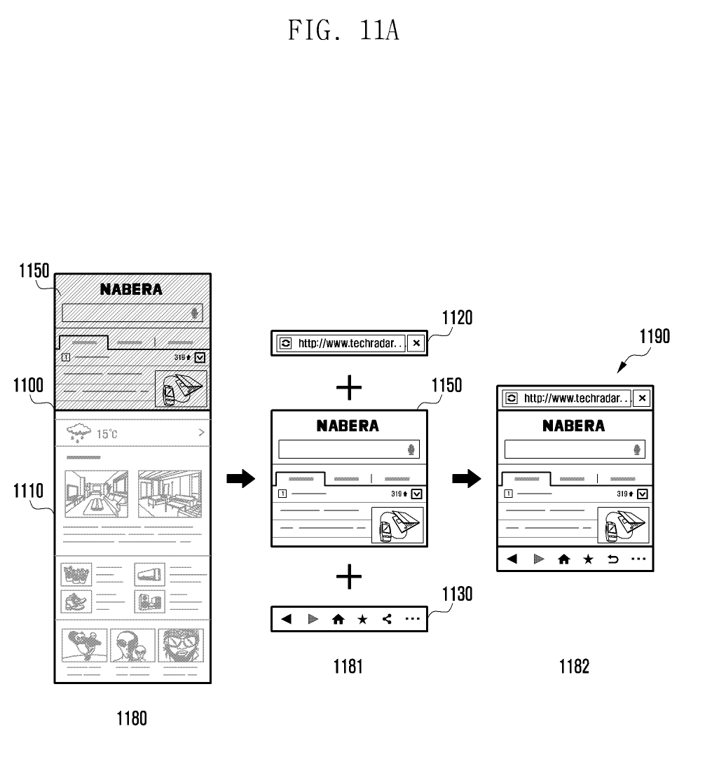

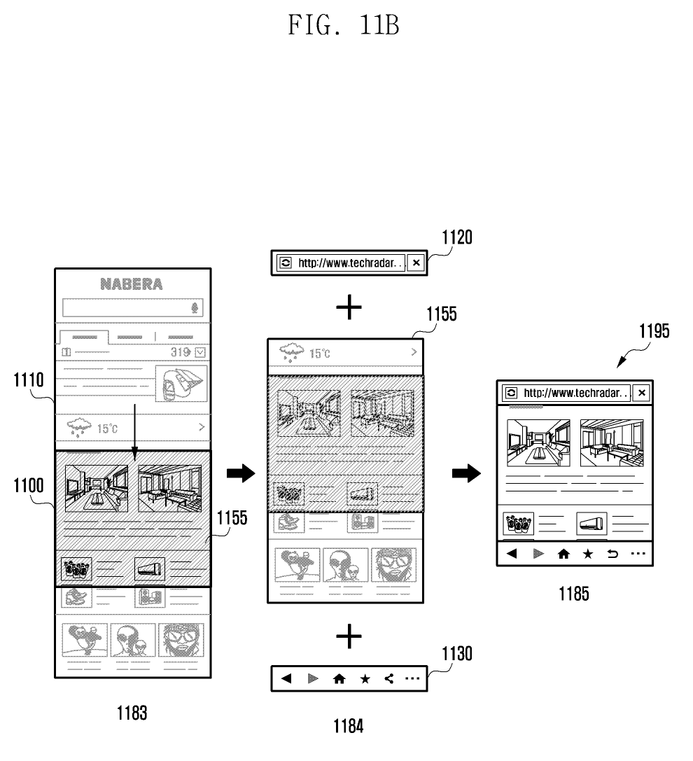

FIGS. 11A and 11B are diagrams illustrating a screen display method of an electronic device, according to an embodiment of the present disclosure.

In FIG. 11A, the electronic device may execute an application, generate a plurality of surface images associated with the executed application, and store the surface images in a storage structure. The electronic device may check for the transitioning surface images among all of the surface images in response to a screen transition input made by the user. According to an embodiment of the present disclosure, the application may be a web browser.

As denoted by reference numeral 1180, the electronic device may check the surface image for its part corresponding to the screen display window.

As denoted by reference numeral 1181, the electronic device may generate a screen page based on the checked part of the surface image. The electronic device may compose the checked part of the surface image and the surface images generated in association with the execution of the application into a screen page to be displayed on the screen. The surface images may include an address window and a task bar. The task bar may include buttons for navigating to the previous and next pages in the web browser. The task bar may also include a button for return to the home page. The task bar may also include a button for registering a current page with the favorite list or bookmarking the current page. The task bar may also include a button for sharing the current page with third party users. The task bar may also include a button for checking for other available functions in addition to the aforementioned functions.

As denoted by reference numeral 1182, the electronic device may generate a screen page corresponding to the screen display window using multiple surface images associated with the executed application. The electronic device may display the generated screen page.

As denoted by reference numeral 1183 of FIG. 11B, the electronic device may detect movement of the screen display window. The electronic device may check the surface image for its part corresponding to the moved screen display window.

As denoted by reference numeral 1184, the electronic device may generate a screen page based on the checked part of the surface image. If it is determined that parts of multiple surface images correspond to the screen display window as the screen display window moves, the electronic device may render multiple surface images. The electronic device may compose the newly rendered surface images and the surface images generated in association with the execution of the application into a screen page to be displayed on the screen.

As denoted by reference numeral 1185, the electronic device may generate a screen page corresponding to the position of the screen display window by composing the surface images associated with the executed application. The electronic device may display the generated screen page.

As described above, the electronic device and screen display method of the present disclosure is advantageous in terms of reducing performance degradation and power consumption caused by frequent rendering by storing rendered images in advance and displaying the rendered images in response to a user input for navigating the image viewed on the display screen.

While the present disclosure has been shown and described with reference to certain embodiments thereof, it should be understood by those skilled in the art that various changes in form and details may be made therein without departing from the spirit and scope of the present disclosure, as defined by the appended claims and their equivalents.

What is claimed is:

1. An electronic device comprising:
a display including a touchscreen panel;
a processor; and
a memory which is electrically connected to the processor and stores commands for executing a surface flinger which generates a screen page based on part of at least one surface image corresponding to a screen display window among a plurality of surface images associated with an application,
wherein the memory stores commands, which when executed, cause the processor to:
generate the plurality of surface images associated with the application,
store the surface images in the memory,
check the at least one surface image for a first part corresponding to the screen display window,
generate a first screen page based on the first part,
display the first screen page on the display,
check, when movement of the screen display window is detected, the at least one surface image for a second part corresponding to the moved screen display window,
generate a second screen page based on the second part, and
display the second screen page in place of the first screen page on the display.

2. The electronic device of claim 1, wherein the memory stores a command for instructing the processor to render the surface images and store the rendered surface images in the memory.

3. The electronic device of claim 1, wherein the memory stores a command for instructing the processor to render, when at least one of the surface images has information changed, a surface image based on information before and after the change.

4. The electronic device of claim 1, wherein the memory stores a command for instructing the processor to store the surface images in the memory.

5. The electronic device of claim 4, wherein the surface images correspond to the screen display window.

6. The electronic device of claim 1, wherein the screen display window is moved according to a screen transition input made on the touch panel.

7. The electronic device of claim 1, wherein the memory comprises a frame buffer.

8. A screen display method of an electronic device, the method comprising:
generating a plurality of surface images associated with an application;
storing the surface images in a memory;
checking at least one surface image for a first part corresponding to a screen display window;
generating a first screen page based on the first part;
displaying the first screen page on a display;
rechecking, when movement of the screen display window is detected, the at least one surface image for a second part corresponding to the moved screen display window;
generating a second screen page based on the second part; and
displaying the second screen page in place of the first screen page on the display.

9. The method of claim 8, wherein generating the plurality of surface images comprises rendering the surface images associated with the application.

10. The method of claim 9, further comprising rendering, when information of at least one of the surface images has changed, a surface image based on the information before and after the change.

11. The method of claim 10, wherein the surface images correspond to the screen display window.

12. The method of claim 10, wherein generating the first screen page comprises composing the first part of the surface image corresponding to the screen display window and other surface images.

13. The method of claim 8, wherein the screen display window is moved according to a screen transition input made on a touch panel.

14. The method of claim 8, wherein rechecking the at least one surface image comprises rechecking a second part of the surface image corresponding to the moved screen display window.

15. The method of claim 14, wherein generating the second screen page comprises composing the second part of the surface image and other surface images.
